(19) United States
(12) Patent Application Publication
(10) Pub. No.: US 2010/0140549 A1
(43) Pub. Date: Jun. 10, 2010

(54) METAL MIXED OXIDE, PHOSPHOR, PHOSPHOR PASTE AND LIGHT-EMITTING DEVICE

(75) Inventors: Satoru Kuze, Ibaraki (JP); Yoshiko Nakamura, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, CHUO-KU, TOKYO (JP)

(21) Appl. No.: 12/515,303

(22) PCT Filed: Nov. 19, 2007
(86) PCT No.: PCT/JP2007/072706

§ 371 Date: Dec. 8, 2009

(30) Foreign Application Priority Data
Nov. 22, 2006 (JP) 2006-315314

(51) Int. Cl. C09K 11/55

(52) U.S. Cl. 252/301.4 R

(57) ABSTRACT

Disclosed is a metal mixed oxide which enables to obtain a phosphor exhibiting higher emission luminance. Also disclosed are a phosphor containing such a metal mixed oxide, a phosphor paste and a light-emitting device. The metal mixed oxide contains the following (1), (2) and (3) as metal elements: (1) (an) alkaline earth metal element(s) selected from Ba, C and Mg; (2) aluminum (Al); and (3) at least one element (M) selected from rare earth elements and manganese. In this connection, when the molar ratio of Ba:Ca:Mg:Al:M is expressed as a:b:c:d:e, the following relations are satisfied: 0.3≦a≦8, 0≦b<12.5, 0≦c<12.5, 11≦a+b+c≦13, 13≦d≦15, 0.0001≦e≦1.0.

### TECHNICAL FIELD

The present invention relates to a metal mixed oxide, a phosphor, a phosphor paste and a light-emitting device.

### BACKGROUND ART

The metal mixed oxides are used for ultraviolet shield materials, paints, phosphors and the like. Among them, since the phosphors emit light when exposed to an excitation source, the phosphors are used for light-emitting devices. In respect to the light-emitting devices, there are known various types of light-emitting devices, which include, for instance, electron beam-excited light-emitting devices which make use of electron beams as a phosphor excitation source (such as cathode ray tube, field emission display and surface field display), ultraviolet light-excited light-emitting devices using ultraviolet light as a phosphor excitation source (such as backlight for liquid crystal display, 3-wavelength type fluorescent lamp and high-load fluorescent lamp), vacuum ultraviolet light-excited light-emitting devices using vacuum ultraviolet light as a phosphor excitation source (such as plasma display panel and rare gas lamp), and white LED using light emitted by blue LED or ultraviolet LED as a phosphor excitation source.

As the conventional metal mixed oxides used for the phosphors, there is known, for instance, a metal mixed oxide represented by the formula Ca_{11.76}Eu_{0.24}Al₁₄O₃₃ (JP-A-2004 -300261).

The phosphors comprising the metal mixed oxide disclosed in the above patent document, however, are unsatisfactory in emission luminance.

### DISCLOSURE OF THE INVENTION

The purpose of the present invention is to provide a metal mixed oxide which is capable of providing a phosphor exhibiting higher emission luminance, a phosphor containing such a metal mixed oxide, a phosphor paste using such a phosphor, and a light-emitting device making use of such a phosphor.

The present inventors have pursued studies for solving the above problem and, as a result, reached the present invention.

The present invention provides <1> to <9> set forth below:
<1> A metal mixed oxide containing the following (1),(2) and (3) as metal elements:
(1) (an) alkaline earth metal element(s) selected from Ba, Ca and Mg;
(2) aluminum (Al); and
(3) at least one element (M) selected from the group consisting of rare earth elements and manganese; wherein when the molar ratio of Ba:Ca:Mg:Al:M is expressed as a:b:c:d:e, the following relations are satisfied:

0.3≦a≦8,

0≦b<12.5,

0≦c<12.5,

11≦a+b+c≦13,

13≦d≦15, and

0.0001≦e≦1.0.
<2> The metal mixed oxide according to item <1> wherein M is at least one element selected from the group consisting of Eu and Tb.
<3> The metal mixed oxide according to item <1> or <2> which satisfies the following relations: c=0, a+b+c=12, and d=14.
<4> The metal mixed oxide according to item <3> which satisfies the following relation: 0.5≦a≦6.
<5> A phosphor comprising the metal mixed oxide set forth in any one of items <1> to <4>.
<6> A phosphor paste containing the phosphor set forth in item <5>.
<7> A phosphor layer obtained by applying the phosphor paste set forth in item <6> on a substrate, followed by a heat treatment.
<8> A light-emitting device comprising the phosphor set forth in item <5>.
<9> A vacuum ultraviolet light-excited light-emitting device comprising the phosphor set forth in item <5>.
<10> Use of the phosphor of item <5> for a vacuum ultraviolet light-excited light-emitting device.

### EMBODIMENTS FOR CARRYING OUT THE INVENTION

### Metal Mixed Oxide

The metal mixed oxide according to the present invention contains, as its metal elements, (1) (an) alkaline earth metal element(s) selected from Ba, Ca and Mg, (2) aluminum (Al) and (3) at least one element (M) selected from the group consisting of rare earth elements and manganese.

Regarding the metal mixed oxide of the present invention, when the molar ratio of Ba:Ca:Mg:Al:M is expressed as a:b:c:d:e, a is in the range of from 0.3 to 8, preferably from 0.5 to 6, b is in the range of 0 or more but less than 12.5, c is in the range of 0 or more but less than 12.5, with a+b+c falling in the range of from 11 to 13, d is in the range of from 13 to 15, and e is in the range of from 0.0001 to 1.0, preferably from 0.0001 to 0.5. The ratio of e is preferably not less than 0.001 from the viewpoint of luminous intensity but is preferably not greater than 0.1 from the viewpoint of production cost.

In the metal mixed oxide, M, which is at least one element selected from the group consisting of rare earth elements and manganese, plays a pivotal role as a luminous element, functioning as an activator. M may be, for instance, Eu, Ce, Pr, Nd, Sm, Tb, Dy, Er, Tm, Yb, Bi or Mn, preferably is Eu or Tb for more enhancing emission luminance. These elements may be used singly or in combination. It is preferable for further enhancing emission luminance that M is Eu alone or Tb alone. When M is Eu alone or Tb alone or a combination of Eu and Tb, a part of Eu or Tb may be substituted with a co-activator for particularly elevating emission luminance. The co-activators usable here include, for instance, Sc, Y, La, Gd, Ce, Pr, Nd, Pm, Sm, Dy, Ho, Er, Tm, Yb, Lu, Bi, Au, Ag, Cu and Mn. These elements may be used singly or in combination. The rate of substitution is normally not more than 50 mol % of Eu and/or Tb.

The metal mixed oxide of the present invention preferably satisfies at least one of the following conditions (I), (II) and (III), more preferably all of these conditions for maximizing emission luminance:

c=0; (I)

a+b+c=12; (II)

d=14. (III)

As mentioned above, high emission luminance is obtained when a is in the range of from 0.5 to 6, and also an enhancement of luminance is provided when the (I), (II) and (III) are satisfied. In that condition, b=12−a. The present inventors surmise that the metal mixed oxide that satisfies the above conditions (I), (II) and (III) has a structure in which barium (Ba), calcium (Ca), aluminum (Al) and oxygen (O) form a cage-like crystal structure, and M is present in the cage to perform its role as an activator; and surmise that in the phosphor comprising the metal mixed oxide, the cage-like crystal structure efficiently absorbs an energy irradiated from an excitation source and the absorbed energy is efficiently transmitted to the activator, thereby the emission luminance can be enhanced.

The metal mixed oxide can be produced by, for instance, baking a mixture of the metal compounds which can be made into a metal mixed oxide by baking. More specifically, the metal mixed oxide can be produced by a method of weighing out the compounds containing the respective metal elements constituting the metal mixed oxide so as to provide a desired composition, mixing the compounds to obtain a mixture of the metal compounds, and baking this mixture, or a method of obtaining a mixture of the metal compounds by a crystallization method and baking the mixture. For instance, a metal mixed oxide having a composition of Ba:Ca:Al:Eu=1:11:14:0.05 in molar ratio can be produced by weighing out the respective starting materials CaCO₃, BaCO₃, Al₂O₃ and Eu₂O₃, mixing them to obtain a mixture of the metal compounds having a Ba:Ca:Al:Eu molar ratio of 1:11:14:0.05, and baking this mixture.

The compound containing the metal element can be any of a compound of Ba, Ca, Mg, Al or M, for instance, an oxide of this element or its hydroxide, carbonate, nitrate, halide or oxalate which can be turned into an oxide by high-temperature decomposition and/or oxidation.

It is also possible to use halide such as fluoride and chloride as the compound containing the metal element. The halide may serve as a reaction promoter (flux), so that by using an appropriate amount of halide, there can be obtained a metal mixed oxide which is controlled in crystallizability and average particle size in the course of baking described below. As the flux, it is possible to use, for instance, LiF, NaF, KF, LiCl, NaCl, KCl, Li₂CO₃, Na₂CO₃, K₂CO₃, NaHCO₃, NH₄Cl, NH₄I, MgF₂, CaF₂, SrF₂, BaF₂, MgCl₂, CaCl₂, SrCl₂, BaCl₂, MgI₂, CaI₂, SrI₂ and BaI₂.

Mixing can be effected by using an apparatus such as ball mill, V-type mixer, stirrer, etc. Mixing may be effected in dry type or wet type.

In case the mixture of the metal compounds contains the compounds which can be made into oxides by high temperature decomposition and/or oxidation, the mixture may be subjected to calcination. Such calcination may be conducted at a temperature of or lower than a retention temperature of baking described below. Calcination may be employed for oxidizing the compounds or removing crystal water contained in the compounds. Such calcination may be carried out in an inert gas atmosphere, an oxidizing atmosphere or a reducing atmosphere. The calcined product may be pulverized.

Baking may be conducted at a retention temperature in the range of from approximately 600° C. to approximately 1,600° C. for a period of about 0.5 hour to about 100 hours. For producing the metal mixed oxide satisfying the above-mentioned conditions (I), (II) and (III), baking is preferably carried out at a retention temperature in the range of from approximately 1,100° C. to approximately 1,300° C.

Baking can be performed in an atmosphere properly selected in accordance with the type of M used, such as an atmosphere of an inert gas such as nitrogen or argon, an oxidizing atmosphere of air, oxygen, oxygen-containing nitrogen or oxygen-containing argon, and a reducing atmosphere of hydrogen-containing nitrogen with a hydrogen content of approximately 0.1 to 10 vol % or hydrogen-containing argon with a hydrogen content of approximately 0.1 to 10 vol %. Also, such baking may be conducted after adding a proper amount of carbon to the metal compound mixture. Addition of carbon makes it possible to carry out the baking under a strongly reducing atmosphere. Baking may be conducted twice or more times.

The obtained metal mixed oxide may be pulverized, cleaned and classified as desired. Pulverization may be accomplished by, e.g. a ball mill or a jet mill. The metal mixed oxide may also be subjected to a surface treatment. An example of the surface treatment includes coating a particle surface of the metal mixed oxide with an inorganic material containing Si, Al, Ti or the like.

### Phosphor

The phosphor according to the present invention contains the metal mixed oxide described above. The phosphor may comprise the metal mixed oxide alone or may contain a metal mixed oxide which has undergone a surface treatment such as coating. This phosphor emits light with high luminance when exposed to various types of excitation source.

### Phosphor Paste

The phosphor paste according to the present invention normally comprises the above-described phosphor of the present invention and organic materials which may be, for instance, a solvent or a binder. This phosphor paste is applied on a substrate to form a film and heat treated to remove the organic material in the paste by evaporation, combustion or decomposition, thereby forming a phosphor layer which is substantially composed of the phosphor.

The phosphor paste can be produced by a known method such as a method disclosed in JP-A-10-255671, which comprises mixing a phosphor, a binder and a solvent by a ball mill, three-roll mill or like means.

The binders include a cellulosic resin (such as ethyl cellulose, methyl cellulose, nitrocellulose, acetyl cellulose, cellulose propionate, hydroxypropyl cellulose, butyl cellulose, benzyl cellulose and modified cellulose), an acrylic resin (a polymer comprising at least one of monomers such as acrylic acid, methacrylic acid, methyl acrylate, methyl methacrylate, ethyl acrylate, ethyl methacrylate, propyl acrylate, propyl methacrylate, isopropyl acrylate, isopropyl methacrylate, n-butyl acrylate, n-butyl methacrylate, tert-butyl acrylate, tert-butyl methacrylate, 2-hydroxyethyl acrylate, 2-hydroxyethyl methacrylate, 2-hydroxypropyl acrylate, 2-hydroxypropyl methacrylate, benzyl acrylate, benzyl methacrylate, phenoxy acrylate, phenoxy methacrylate, isobornyl acrylate, isobornyl methacrylate, glycidyl methacrylate, styrene, α-methylstyrene acrylamide, methacrylamide, acrylonitrile, and methacrylonitrile), ethylene-vinyl acetate copolymer resin, polyvinyl butyral, polyvinyl alcohol, propylene glycol, polyethylene oxide, urethane-based resin, melamine-based resin, and phenolic-based resin.

Examples of the solvent include monohydric alcohols having high boiling point; polyhydric alcohols such as diols and triols, representative examples of which are ethylene glycol and glycerin; and compounds formed by etherifying and/or esterifying an alcohol (such as ethylene glycol monoalkyl ether, ethylene glycol dialkyl ether, ethylene glycol alkyl ether acetate, diethylene glycol monoalkyl ether acetate, diethylene glycol dialkyl ether, propylene glycol monoalkyl ether, propylene glycol dialkyl ether, and propylene glycol alkyl acetate).

A phosphor layer formed by coating the thus obtained phosphor on a substrate and subjecting it to a heat treatment has high emission luminance. The substrate may be, for instance, one made of glass or resin. Also, it may be of a flexible type, and its shape is diversified, such as plate-like or vessel-like. Screen printing, ink jet printing or other like methods may be used for coating. The heat treatment may usually be conducted at a temperature of from 300° C. to 600° C. After coating, the substrate may be dried at a temperature of from room temperature to 300° C. prior to the heat treatment.

### Light-Emitting Devices

The light-emitting device according to the present invention comprises the phosphor described above. The light-emitting device normally comprises the phosphor, its excitation source and optionally the other phosphor(s). Examples of the other phosphor is a red phosphor.

A plasma display panel, which is a vacuum ultraviolet light-excited light-emitting device, is taken up here as an example of the light-emitting devices according to the present invention, and its production process is illustrated below. The conventional methods such as a method disclosed in JP-A-10-195428 can be used for producing a plasma display panel. In case the above-described phosphor is one which emits light of blue color, each of the compositional phosphors, viz. a green phosphor, a red phosphor and the above-mentioned blue phosphor, is mixed with a binder composed of, for instance, a cellulose resin or polyvinyl alcohol and a solvent to prepare a phosphor paste. The phosphor pastes are applied by a means such as screen printing on the striped substrate surface comparted by a partition wall and provided with an address electrode as well as on the partition wall surface on the inside of the back substrate, and heat treated at a temperature in the range of from 300° C. to 600° C. to obtain a phosphor layer. Placed and bonded on this phosphor layer is a frontal glass substrate provided with a transparent electrode and a bus electrode positioned in the direction perpendicular to the phosphor layer and also having on its inner side a dielectric layer and a protective layer. The inside of the assembly is evacuated and filled with a low pressure rare gas such as Xe or Ne to form a discharge space, thus producing a plasma display panel.

A field emission display, which is an electron beam-excited light-emitting device, taken up here as another example of the light-emitting devices according to the present invention is described below regarding its production process. A known method such as disclosed in JP-A-2002-138279 can be used for producing a field emission display. In case the above-described phosphor is one which emits light of blue color, each of the compositional phosphors, viz. a green phosphor, a red phosphor and the above-described blue phosphor, is dispersed in an aqueous solution of polyvinyl alcohol or the like to prepare a phosphor paste. The phosphor pastes are applied on a glass substrate and heat treated to form a phosphor layer, thus making a face plate. This face plate and a rear plate having a plurality of electron releasing elements are assembled together with the aid of a support frame and the assembly is passed through the ordinary steps such as hermetic sealing while evacuating the spaces in the assembly, thereby making a field emission display.

The production process of a white LED, yet another example of the light-emitting devices according to the present invention, is explained below. The known methods such as disclosed in JP-A-5-152609 and JP-A-7-99345 can be used for producing a white LED. The phosphors including at least the above-described phosphor are dispersed in a light-transmitting resin such as epoxy resin, polycarbonate or silicon rubber, and the phosphors-dispersed resin is molded in such a manner as to enclose the blue LED or ultraviolet LED, thereby producing a white LED.

The production process of a high-load fluorescent lamp (a small-sized fluorescent lamp with a high power consumption per unit area of the lamp pipe wall), which is a ultraviolet light-excited light-emitting device and cited here as still another example of the light-emitting devices according to the present invention, is described below. A known method such as described in JP-A-10-251636 can be used for producing a high-load fluorescent lamp. In case the above-described phosphor is one which emits light of blue color, each of the compositional phosphors, viz. a green phosphor, a red phosphor and the above-described particulate blue phosphor is dispersed in an aqueous solution of polyethylene oxide or the like to prepare a phosphor paste. This phosphor paste is applied on the inner wall of the glass tube, dried and then heat treated at a temperature in the range of from 300° C. to 600° C. to form a phosphor layer. After attaching a filament, the phosphor layer is passed through the ordinary steps such as evacuation, then a low pressure rare gas such as Ar, Kr or Ne is sealed therein and caps are mounted so as to form a discharge space, thereby making a high-load fluorescent lamp.

### EXAMPLES

The present invention is further illustrated by its embodiments, but it is to be understood that the present invention is not limited to these embodiments.

### Comparative Example 1

### [Preparation of Mixture]

Calcium carbonate (produced by Ube Materials Co., Ltd.; purity: 99% or above), aluminum oxide (produced by Sumitomo Chemical Co., Ltd.; purity: 99% or above), and europium oxide (produced by Shin-Etsu Chemical Industries Co., Ltd.; purity: 99.99%) were weighed out and were mixed by a dry ball mill for 4 hours to obtain a mixture having a composition of Ca:Al:Eu=12:14:0.05 in molar ratio.

### [Baking]

The above mixture was packed in an alumina boat and the alumina boat was set in a baking furnace. The mixture was baked at 1,200° C. for 2 hours in a reducing atmosphere of a nitrogen gas containing 2 vol % of hydrogen to obtain a phosphor B1 comprising a metal mixed oxide.

### [Phosphor Evaluation 1]

The phosphor B1 was irradiated with vacuum ultraviolet light from an excimer 146 nm lamp (H0012 mfd. by Ushio Inc.) in a vacuum chamber of 6.7 Pa (5×10⁻² Torr) or below at room temperature (approximately 25° C.) to let the phosphor emit light. The peak wavelength and luminance of the emitted light were measured by a spectroradiometer (SR-3 mfd. by Topcon Corp.). The luminance of the emitted light observed at that moment is here assumed to be 100. The thus determined physical properties (ratios of metal elements, maximum peak wavelength and luminance) of the phosphor B1 are shown in Table 1.

### [Phosphor Evaluation 2]

The phosphor B1 was irradiated with vacuum ultraviolet light from an excimer 172 nm lamp (H0016 mfd. by Ushio Inc.) in a vacuum chamber of 6.7 Pa (5×10⁻² Torr) or below at room temperature (approximately 25° C.) to let the phosphor emit light, and the peak wavelength and luminance of the emitted light were measured a spectroradiometer (SR-3 mfd. by Topcon Corp.). The luminance of this phosphor at that moment is assumed to be 100. The thus determined physical properties (maximum peak wavelength and luminance) of the phosphor B1 are shown in Table 1.

### Comparative Example 2

Barium carbonate (produced by Nippon Chemical Industries Co., Ltd.; purity: 99% or above), calcium carbonate (produced by Ube Materials Co., Ltd.; purity: 99% or above), aluminum oxide (produced by Sumitomo Chemical Co., Ltd.; purity: 99% or above) and europium oxide (produced by Shin-Etsu Chemical Industries Co., Ltd.; purity: 99.99%) were weighed out and were mixed by a dry ball mill for 4 hours to obtain a mixture having a composition of Ba:Ca:Al:Eu=0.1:11.9:14:0.05 in molar ratio.

This mixture was treated according to the same procedure as conducted in [Baking] of Comparative Example 1 to obtain a phosphor B2 comprising a metal mixed oxide. The phosphor B2 was evaluated under the same conditions as used in [Phosphor evaluation 1] and [Phosphor evaluation 2] of Comparative Example 1. The results are shown in Table 1.

### Example 1

A phosphor B3 comprising a metal mixed oxide was obtained by following the same procedure as conducted in Comparative Example 2 except that the molar ratio of Ba:Ca:Al:Eu was changed to 0.5:11.5:14:0.05. The phosphor B3 was evaluated under the same conditions as used in [Phosphor evaluation 1] and [Phosphor evaluation 2] of Comparative Example 1. The results are shown in Table 1.

### Example 2

A phosphor B4 comprising a metal mixed oxide was obtained by following the same procedure as conducted in Comparative Example 2 except that the molar ratio of Ba:Ca:Al:Eu was changed to 1:11:14:0.05. The phosphor B4 was evaluated under the same conditions as used in [Phosphor evaluation 1] and [Phosphor evaluation 2] of Comparative Example 1. The results are shown in Table 1.

### Example 3

A phosphor B5 comprising a metal mixed oxide was obtained by following the same procedure as conducted in Comparative Example 2 except that the molar ratio of Ba:Ca:Al:Eu was changed to 3:9:14:0.05. The phosphor B5 was evaluated under the same conditions as used in [Phosphor evaluation 1] and [Phosphor evaluation 2] of Comparative Example 1. The results are shown in Table 1.

### Example 4

A phosphor B6 comprising a metal mixed oxide was obtained by following the same procedure as conducted in Comparative Example 2 except that the molar ratio of Ba:Ca:Al:Eu was changed to 6:6:14:0.05. The phosphor B6 was evaluated under the same conditions as used in [Phosphor evaluation 1] and [Phosphor evaluation 2] of Comparative Example 1. The results are shown in Table 1.

### Comparative Example 3

Barium carbonate (produced by Nippon Chemical Industries Co., Ltd.; purity: 99% or above), aluminum oxide (produced by Sumitomo Chemical Co., Ltd.; purity: 99% or above) and europium oxide (produced by Shin-Etsu Chemical Industries Co., Ltd.; purity: 99.99%) were weighed out and were mixed by a dry ball mill for 4 hours to obtain a mixture having a composition of Ba:Al:Eu=12:14:0.05 in molar ratio.

The mixture was treated by the same operation as in [Baking] of Comparative Example 1 to obtain a phosphor B7 comprising a metal mixed oxide. The phosphor B7 was evaluated under the same conditions as used in [Phosphor evaluation 1] and [Phosphor evaluation 2] of Comparative Example 1. The results are shown in Table 1.

### Comparative Example 4

Calcium carbonate (produced by Ube Materials Co., Ltd.; purity: 99% or above), aluminum oxide (produced by Sumitomo Chemical Co., Ltd.; purity: 99% or above) and terbium oxide (produced by Shin-Etsu Chemical Industries Co., Ltd.; purity: 99.99%) were weighed out and were mixed by a dry ball mill for 4 hours to obtain a mixture having a composition of Ca:Al:Tb=12:14:0.05 in molar ratio. The mixture was treated by the same operation as in [Baking] of Comparative Example 1 to obtain a phosphor G1 comprising a metal mixed oxide.

### [Phosphor Evaluation 3]

The phosphor G1 was irradiated with vacuum ultraviolet light from an excimer 146 nm lamp (H0012 mfd. by Ushio Inc.) in a vacuum chamber of 6.7 Pa (5×10⁻² Torr) or below at room temperature (approximately 25° C.) to let the phosphor emit light. The peak wavelength and luminance of the emitted light were measured by a spectroradiometer (SR-3 mfd. by Topcon Corp). The luminance of the emitted light observed at that moment is here assumed to be 100. The thus determined physical properties (ratios of metal elements, maximum peak wavelength and luminance) of the phosphor G1 are shown in Table 2.

### [Phosphor Evaluation 4]

The phosphor G1 was irradiated with vacuum ultraviolet light from an excimer 172 nm lamp (H0016 mfd. by Ushio Inc.) in a vacuum chamber of 6.7 Pa (5×10⁻² Torr) or below at room temperature (approximately 25° C.) to let the phosphor emit light. The peak wavelength and luminance of the emitted light were measured by a spectroradiometer (SR-3 mfd. by Topcon Corp). The luminance of the emitted light observed at that moment is here assumed to be 100. The thus determined physical properties (maximum peak wavelength and luminance) of the phosphor G1 are shown in Table 2.

### Example 5

Barium carbonate (produced by Nippon Chemical Industries Co., Ltd.; purity: 99% or above), calcium carbonate (produced by Ube Materials Co., Ltd.; purity: 99% or above), aluminum oxide (produced by Sumitomo Chemical Co., Ltd,; purity: 99% or above) and terbium oxide (produced by Shin-Etsu Chemical Industries Co., Ltd.; purity: 99.99%) were weighed out and were mixed by a dry ball mill for 4 hours to obtain a mixture having a composition of Ba:Ca:Al:Tb of 1:11:14:0.05 in molar ratio. The mixture was treated by the same operation as conducted in [Baking] of Comparative Example 1 to obtain a phosphor G2 comprising a metal mixed oxide. The phosphor G2 was evaluated under the same conditions as used in [Phosphor evaluation 3] and [Phosphor evaluation 4] of Comparative Example 4. The results are shown in Table 2.

### Example 6

A phosphor G3 comprising a metal mixed oxide was obtained by following the same procedure as conducted in Example 5 except that the molar ratio of Ba:Ca:Al:Tb was changed to 3:9:14:0.05. The phosphor G3 was evaluated under the same conditions as used in [Phosphor evaluation 3] and [Phosphor evaluation 4] of Comparative Example 4. The results are shown in Table 2.

TABLE 1
Physical properties of the phosphors

| | Phosphors | | | |
|---|---|---|---|---|
| | | | | Relative |
| | | | Peak wave- | luminance |
| | | | length when | when excited |
| | | Ratios of | excited by | by 146 nm |
| | No | metal elements | 146 nm VUV | VUV |
| Comp. Example 1 | B1 | Ca:Al:Eu = | 435 nm | 100 |
| | | 12:14:0.05 | | |
| Comp. Example 2 | B2 | Ba:Ca:Al:Eu = | 437 nm | 110 |
| | | 0.1:11.9:14:0.05 | | |
| Example 1 | B3 | Ba:Ca:Al:Eu = | 441 nm | 580 |
| | | 0.5:11.05:14:0.05 | | |
| Example 2 | B4 | Ba:Ca:Al:Eu = | 441 nm | 1747 |
| | | 1:11:14:0.05 | | |
| Example 3 | B5 | Ba:Ca:Al:Eu = | 441 nm | 1629 |
| | | 3:9:14:0.05 | | |
| Example 4 | B6 | Ba:Ca:Al:Eu = | 490 nm | 1265 |
| | | 6:6:14:0.05 | | |
| Comp. | B7 | Ba:Al:Eu = | 501 nm | 235 |
| Example 3 | | 12:14:0.05 | | |

Phosphors

| | | Relative |
|---|---|---|
| | Peak wave- | luminance |
| | length when | when excited |
| | excited by | by 172 nm |
| | 172 nm VUV | VUV |
| Comp. Example 1 | 448 nm | 100 |
| Comp. Example 2 | 446 nm | 112 |
| Example 1 | 442 nm | 508 |
| Example 2 | 442 nm | 1607 |
| Example 3 | 442 nm | 1622 |
| Example 4 | 490 nm | 1561 |
| Comp. Example 3 | 497 nm | 309 |

TABLE 2
Physical properties of phosphors

| | Phosphors | | | |
|---|---|---|---|---|
| | | | | Relative |
| | | | Peak wave- | luminance |
| | | | length when | when excited |
| | | Ratios of | excited by | by 146 nm |
| | No | metal elements | 146 nm VUV | VUV |
| Comp. Example 4 | G1 | Ca:Al:Tb = | 545 nm | 100 |
| | | 12:14:0.05 | | |
| Example 5 | G2 | Ba:Ca:Al:Tb = | 545 nm | 819 |
| | | 1:11:14:0.05 | | |
| Example 6 | G3 | Ba:Ca:Al:Tb = | 545 nm | 741 |
| | | 3:9:14:0.05 | | |

Phosphors

| | | Relative |
|---|---|---|
| | Peak wave- | luminance |
| | length when | when excited |
| | excited by | by 172 nm |
| | 172 nm VUV | VUV |
| Comp. Example 4 | 545 nm | 100 |
| Example 5 | 545 nm | 1247 |
| Example 6 | 545 nm | 1074 |

### INDUSTRIAL APPLICABILITY

According to the present invention, it is possible to obtain a metal mixed oxide which is capable of providing a phosphor exhibiting high emission luminance. The phosphor containing such a metal mixed oxide can be applied to the ultraviolet light-excited light-emitting devices such as backlight for liquid crystal display, electron beam-excited light-emitting devices such as field emission display, light-emitting devices such as white LED, and most advantageously vacuum ultraviolet light-excited light-emitting devices such as plasma display panels. Also, the metal mixed oxide according to the present invention is applicable to the ultraviolet shield materials and paints.

1. A metal mixed oxide containing the following (1), (2) and (3) as metal elements:
(1) (an) alkaline earth metal element(s) selected from Ba, Ca and Mg;
(2) aluminum (Al); and
(3) at least one element (M) selected from the group consisting of rare earth elements and manganese;
wherein when the molar ratio of Ba:Ca:Mg:Al:M is expressed as a:b:c:d:e, the following relations are satisfied:
0.3≦a≦8;
0≦b<12.5;
0≦c<12.5;
11≦a+b+c≦13;
13≦d≦15, and
0.0001≦e≦1.0.

2. The metal mixed oxide according to claim 1 wherein M is at least one element selected from the group consisting of Eu and Tb.

3. The metal mixed oxide according to claim 1 which satisfies the following relations: c=0, a+b+c=12, and d=14.

4. The metal mixed oxide according to claim 3 which satisfies the following relation: 0.5≦a≦6.

5. A phosphor comprising the metal mixed oxide set forth in claim 1.

6. A phosphor paste containing the phosphor set forth in claim 5.

7. A phosphor layer obtained by applying the phosphor paste set forth in claim 6 on a substrate, followed by a heat treatment.

8. A light-emitting device comprising the phosphor set forth in claim 5.

9. A vacuum ultraviolet light-excited light-emitting device comprising the phosphor set forth in claim 5.

10. (canceled)
